(19) United States
(12) Patent Application Publication
(10) Pub. No.: US 2004/0045199 A1
(43) Pub. Date: Mar. 11, 2004

(54) Advertising lighting and interior display

(76) Inventor: Kilwoong Ki, Seoul (KR)

Correspondence Address: BIRCH STEWART KOLASCH & BIRCH, PO BOX 747, FALLS CHURCH, VA, 22040-0747, US

(21) Appl. No.: 10/405,347

(22) Filed: Apr. 3, 2003

Related U.S. Application Data
(63) Continuation-in-part of application No. PCT/KR02/00574, filed on Apr. 2, 2002.

(30) Foreign Application Priority Data
Aug. 3, 2001 (KR) 2001-0047077

(51) Int. Cl. G09F 13/18

(52) U.S. Cl. 40/546

(57) ABSTRACT

An advertising lighting and display device including at least one curved, transparent plate provided with indicia etched into at least one of the surfaces thereof, a light source operatively associated with at least a portion of the edges of said curved plate, said edges having angled and segmented surfaces for increasing the quantity of incident light from the light source with a plurality of light-transmitting color sheets of variable colors attached to said angled and segmented surfaces, and a programmable logic controller operatively connected to the light source for controlling the light color and sequence thereof to be delivered to the edges of the curved plate and ultimately displayed on the curved surface of the display device.

### BACKGROUND OF THE INVENTION

This application is a Continuation-In-Part of co-pending PCT International Application No. PCT/KR02/00574 filed on Apr. 2, 2002, which was not published in English and which designated the United States and on which priority is claimed under 35 U.S.C. § 120, the entire contents of which are hereby incorporated by reference.

1. Field of the Invention

The present invention relates to an improved advertising lighting and interior display device and more particularly, to a light illuminated display, such as a display board which achieves a desired lighting effect with light illumination, using the effect of light refraction and light reflection within a curved surface made of a plastic material, e.g., an acrylic plastic, glass, or crystal plate.

2. Description of the Related Art

Various types of advertising lighting and interior displays are known in the art. Generally, a conventional light illuminated display board is designed to accomplish a desired illumination effect by an edge lighting-type structure. This edge lighting-type structure comprises a plurality of transparent or translucent plastic plates, with the four edge surfaces of each plastic plate being flat and a light source being arranged along each edge of each plate for emitting light to the displaying surface of the display board. In such a conventional edge lighting-type display board, the brightness of the displaying surface of the board is determined only by the arrangement and light intensity of the light sources arranged along the four edges of the plastic plates. Therefore, it is almost impossible for the conventional edge lighting-type display boards to accomplish a desired level of illumination and brightness, the desired alteration of both the illumination and brightness or the desired cubic effect for advertisements or notices displayed on the board.

In order to avoid such problems, U.S. Pat. No. 5,124,890, discloses a display board illuminated by refracted light, comprising a plurality of transparent acrylic plastic plates, in which desired light is received from the light emerging edges of the plastic plates to the light receiving edges of the plates using a light refraction and reflection effect within the transparent acrylic plastic plates. The advertisements or notices of the display board, formed by letters, figures, symbols and/or a combination of them, are illuminated by refracted light. In the above display board, the four edges of each plastic plate are formed to be flat, thus individually having a flat surface.

A variety of lamps in the display board, such as light bulbs, may be preferably used as a light source, illuminating the displaying surface of the board. When the bulbs are arranged within a closed and narrow space formed in the board frame, the bulbs may overheat the plastic plates. When high wattage bulbs are used in the display board in an effort to increase the light intensity of the bulbs and to accomplish a desired brightness of the displaying surface, the bulbs undesirably overheat both the acrylic plastic plates and the color sheets attached to the light receiving edges of the plastic plates. In such a case, the plastic plates and the color sheets may be thermally damaged, discolored, deformed and/or distorted, thus causing a deterioration in both the color alteration and the light intensity of incident light in the case of using the display board for a lengthy period of time. The above display board thus may be remarkably reduced in its advertising effect or its lighting effect.

Also, U.S. Pat. No. 6,308,444, discloses a light illuminated display board and a lampshade using a light refraction and reflection effect in laminated, transparent, acrylic plastic plates which are precisely cut at their four edge surfaces to form individually angled and segmented edge surfaces having two to five surface segrnents. At least one of the opposing surfaces of each plastic plate is inscribed with desired letters, symbols, figures or a combination thereof. The display board or the lampshade of this invention thus clearly displays the desired letters, symbols, figures, or combinations thereof on its display surface while illuminating them using a variety of colored light beams.

Due to heat dissipating bodies disposed between the light bulbs and the angled and segmented edge surfaces of the plastic plates, heat from the light bulbs is actively and effectively dissipated to the surroundings, so that the display board or the lampshade is usable for a lengthy period of time without being thermally distorted or damaged. Each transparent acrylic plastic plate is also provided with grooves having a V-shaped cross-section, scratched areas, and specifically cut color sheets, thereby accomplishing a desired clear displaying effect in addition to a cubic effect for the letters, symbols or figures to be displayed on the display surface. However, since the instant patent is directed to a light illuminated flat display board, it is not applicable to a curved surface of acrylic plastic, glass, or crystal plates.

### SUMMARY OF THE INVENTION

Accordingly, it is an object of the present invention to provide an improved advertising lighting and interior display device which eliminates the above problems encountered with conventional advertising light and interior displays.

Another object of the present invention is to provide an advertising light and interior display device which accomplishes a desired lighting effect utilizing a light refraction and reflection effect within a curved surface of acrylic plastic, glass and/or crystal plates.

A further object of the present invention is to provide a lighting and interior display device which includes a display board frame having first, second and third convex or concave configured and laminated transparent plates, a plurality of light bulbs set along the edges of the plates, and a programmable logic controller for controlling the operation of the light bulbs to produce all types of electrical displays, including interior and exterior lighting displays having wide application for use in large scale outdoor signboards, interior decorations, taillights of vehicles, and the like.

Still another object of the present invention is to provide an advertising lighting and interior display which is simple in structure, inexpensive to manufacture, durable in use, and refined in appearance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front view of a curved, configured advertising display board according to the present invention;

FIG. 2(A) is a front view of the curve, configured advertising display board containing cut-away portions in order to illustrate the construction of the display according to the present invention;

FIG. 2(B) is a perspective view of the curve configured advertising display board containing cut-away portions in order to illustrate the construction of the display board according to the present invention;

FIG. 3(A) is a sectional view of the transparent and convex configured advertising display board taken along line X-X of FIG. 1;

FIG. 3(B) is a sectional view of a partial transparent member of a convex-configured advertising display board according to the present invention;

FIG. 3(C) is a sectional view of a concave configured advertising display board according to the present invention;

FIG. 3(D) is a sectional view of a partial transparent member of the concave configured advertising display board according to the present invention;

FIG. 4 is a diagrammatic sectional view of a curved surface of the transparent and convex configured acrylic plastic, glass, or crystal display board according to the present invention showing an enlarged detail view of a portion thereof;

FIG. 5(A) is a cross-sectional view of the transparent and convex configured acrylic plastic, glass, or crystal display board according to the present invention;

FIG. 5(B) is an exploded perspective view of a center portion of the transparent and convex configured display board assembly of FIG. 5(A);

FIG. 5(C) is a cross-sectional view of the transparent and concave configured acrylic plastic, glass, or crystal display board according to the present invention;

FIG. 5(D) is an exploded perspective view of a center portion of the transparent and concave configured acrylic plastic, glass, or crystal display board according to the present invention;

FIG. 6(A) is a section view of a combined convex and concave configured advertising display board assembly according to the present invention;

FIG. 6(B) is a perspective view of the combined convex and concave configured advertising display board assembly according to the present invention;

FIG. 7 is a perspective view of a second embodiment of the advertising display board according to the present invention;

FIG. 8(A) is a diagrammatic front view of an advertising display board in a first animation operation according to the present invention;

FIG. 8(B) is a diagrammatic front view of an advertising display board in a second animation operation according to the present invention;

FIG. 8(C) is a diagrammatic front view of an advertising display board in a final animation operation according to the present invention;

FIG. 9 is a perspective view of a third embodiment of an indirect convex configured advertising display board installed in a lighting lamp according to the present invention as a wall tapestry;

FIG. 10 is a cross-sectional view of FIG. 9;

FIG. 11 is the perspective view of the third embodiment of an indirect convex configured advertising display board installed in a lighting lamp according to the present invention as a wall tapestry ring;

FIG. 12 is a cross-sectional view of FIG. 11;

FIG. 13 is the perspective view of the third embodiment of an indirect convex configured advertising display board installed in a lighting lamp in the ceiling according to the present invention as a ceiling;

FIG. 14 show an apparatus which can be used for manufacturing the convex at concave surfaces of the display device of the present invention; and

FIG. 14A shows a further embodiment for controlling the extent to which the transparent plate is transformed into a convex concave surface.

### DETAILED DESCRIPTION OF THE PREFERRED EMBODIMENTS

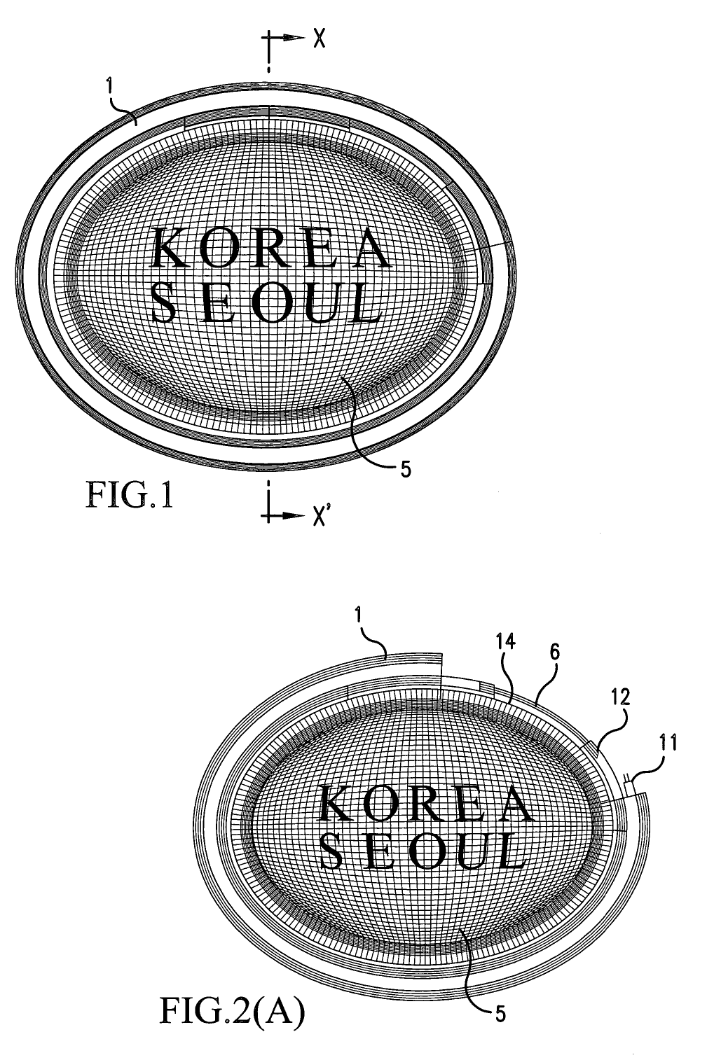

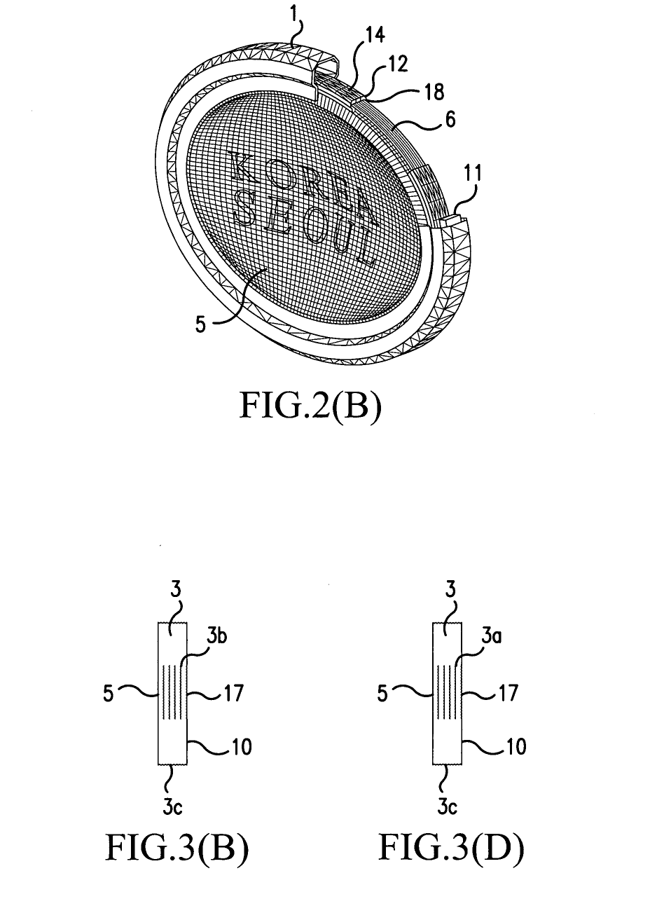

Referring now in detail to the drawings for the purpose of illustrating preferred embodiments of the present invention, the advertising lighting and interior display as shown in FIGS. 1, 2(A) and 2(B) comprises a display board frame 1 with first, second and third curved laminated, transparent acrylic plastic plates 2, 3 and 4, set with the display board frame 1. The curved plates 2, 3 and 4 can have a convex or concave configuration and the laminated transparent plates 2, 3 and 4 can be made of thermoplastic or thermosetting materials, e.g., acrylic plastics, as well as a glass material, a crystal material, or the like.

A plurality of light bulbs 6 are positioned symmetrical along the edges of the curved plates 2, 3 and 4 within the display board frame 1 at regular intervals. In order to separate the light bulb 6 of the first, second and third curved plates 2, 3 and 4 from each other, a pair of lamp partitions 18 are interposed in the laminated junctions of the transparent plates 2, 3 and 4. If the laminated transparent plates are two, the lamp partition is only one. The light bulbs 6 disposed at edges of the plastic plates 2, 3 and 4 emit light into the curved plates 2, 3 and 4 through the symmetrical edges of each plastic plate 2, 3 and 4.

Also, the display board frame 1 has a programmable logic controller (hereinafter “PLC”) 11 used for controlling the operation of the light bulbs 6. The curved plastic plates 2, 3 and 4, the PLC 11, and the lamp partitions 18 are stably and firmly set within the display board frame 1 while being supported by a back plate 8 of the display board frame 1.

The curved plastic plates 2, 3 and 4 are provided with packings 14 disposed between the symmetrical edges thereof for effectively preventing the formation of a color film at the laminated junctions between the three curved plastic plates 2, 3 and 4, and forming desired spaces at the junctions between the plates 2, 3 and 4, thus desirably varying the laminated structure of three curved plates 2, 3 and 4 and the inscription type of advertisements or indirect lighting on the three curved plates 2, 3 and 4 to achieve a desired effect for advertisements and the indirect lighting.

When two lamp partitions 18 are disposed at the laminated junctions of three curved plates 2, 3 and 4 with the light bulbs 6 being controlled by the PLC 11, it is possible to completely change the colors of the letter and/or figures inscribed on three curved plates 2, 3 and 4. This accomplishes an animation effect of the letter and/or figures. Accordingly, the advertising lighting and interior display, according to the present invention, allows a plurality of different color beams to be mixed together within each of the curved plates 2, 3 and 4, so that the curved display board frame 1 displays a variety of colors compared with conventional light illuminated display boards.

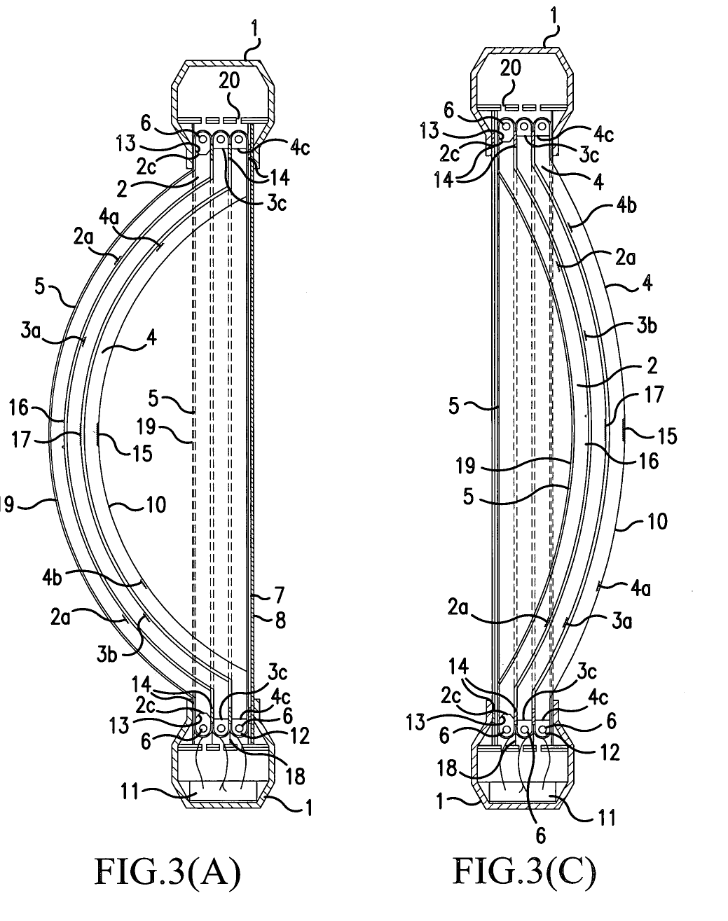

At least one of the opposing surfaces of each plastic plate 2, 3 and 4 is inscribed with letters and/or figures corresponding to those of a curved displaying surface 5 of the interior lighting display of the present invention. As shown in FIG. 3(A), a color reflection plate 7 is attached to both end portions of the third curved plate 4 at the junction between the curved plastic plate 4 and a back plate 8 for reflecting light from the bulbs 6 forward and improving the cubic effect for the advertisements or indirect lightings of the interior lighting display of the present invention. Also, the color reflection plate 7 is firmly held by the back plate 8 of the display of the present invention.

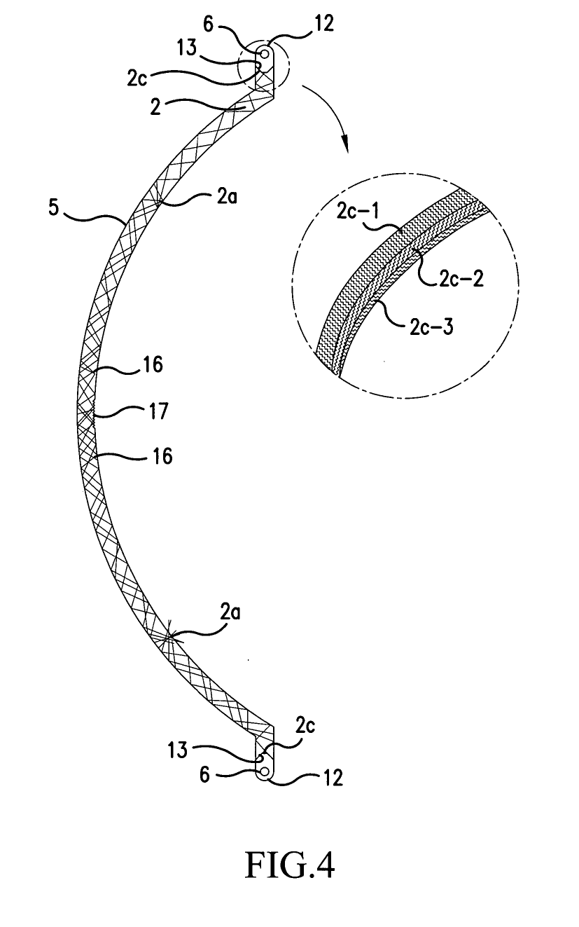

As shown in FIGS. 3(A) and 3(C), the edge surfaces of each curved plastic plate 2, 3 and 4 with one light bulb 6 set along each edge surface are precisely cut to form a variety of specifically angled and segmented surfaces 2C, 3C and 4C. It is preferable to design the shapes of the edge surfaces of each curved plastic plate 2, 3 and 4 to allow each edge surface to have two or three specifically angled surface color segments 2C-1, 2C-2 and 2C-3 (FIG. 4). At this time, it is possible to cut the form surfaces of each plastic plate 2, 3, or 4 to allow each edge space to have a specifically designed cross-section with four or five angled surface color segments, if necessary. That is, four edge surfaces of each curved plastic plate 2, 3 and 4 may be somewhat freely designed to have a plurality of angled surface color segments without affecting the function of the present invention. Accordingly, since such specifically angled and segmented surfaces 2C, 3C, and 4C increase the quantity of incident beams from the light bulbs 6 in addition to the active variation of light transmitting passages within the curved plastic plates 2, 3 and 4 when the beams from the light bulbs 6 pass through the angled and segmented surfaces 2C, 3C and 4C, the interior display device of the present invention displays letters and/or figures in a variety of colors when compared with conventional light illuminated displays.

A plurality of light transmitting color sheets 13 having a variety of colors are attached to the specifically angled and segmented surfaces 2C, 3C and 4C. The angled and segmented surfaces 2C, 3C and 4C are formed on the edge surfaces of the curved plastic plates 2, 3 and 4 through a precision cutting process using a machine tool. The color sheets 13 allow the display of the present invention to effectively display desired letters, figures and/or colors causing light refraction and reflection of the angled and segmented surfaces 2C, 3C and 4C. At this time, a light critical angle is formed.

Also, the color sheets 13 are color bands formed by a combination of a plurality of narrow and wide lines having a variety of colors such as luminosities and hues. As shown in FIGS. 3(C) and 3(D) the color bands are preferably designed by using an appropriate program suitably for accomplishing an operational effect of the lighting and interior display of the present invention so as to display desired letters, figures and their combinations thereof on the curved display surface 5, through illumination with a variety of colored light beams.

As shown in FIGS. 3(A)-3(D), the first plastic plate by its front surface is preferably inscribed with grooves 2a. The second and third plates 3 and 4 may be individually inscribed with grooves 3a and 3b, and 4a and 4b on their opposite surfaces.

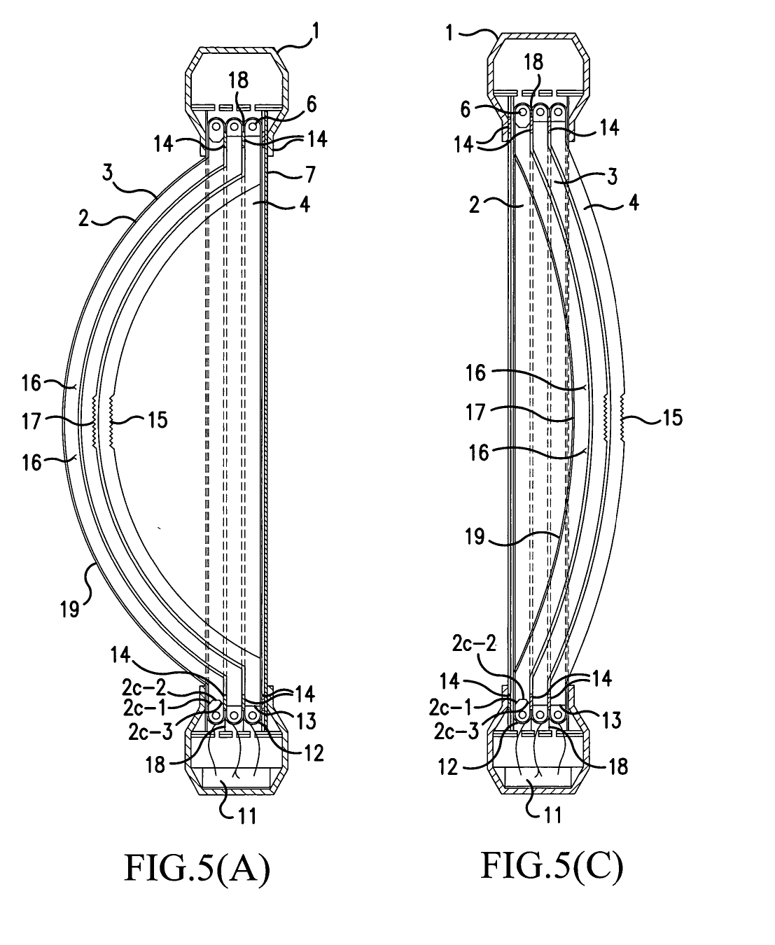

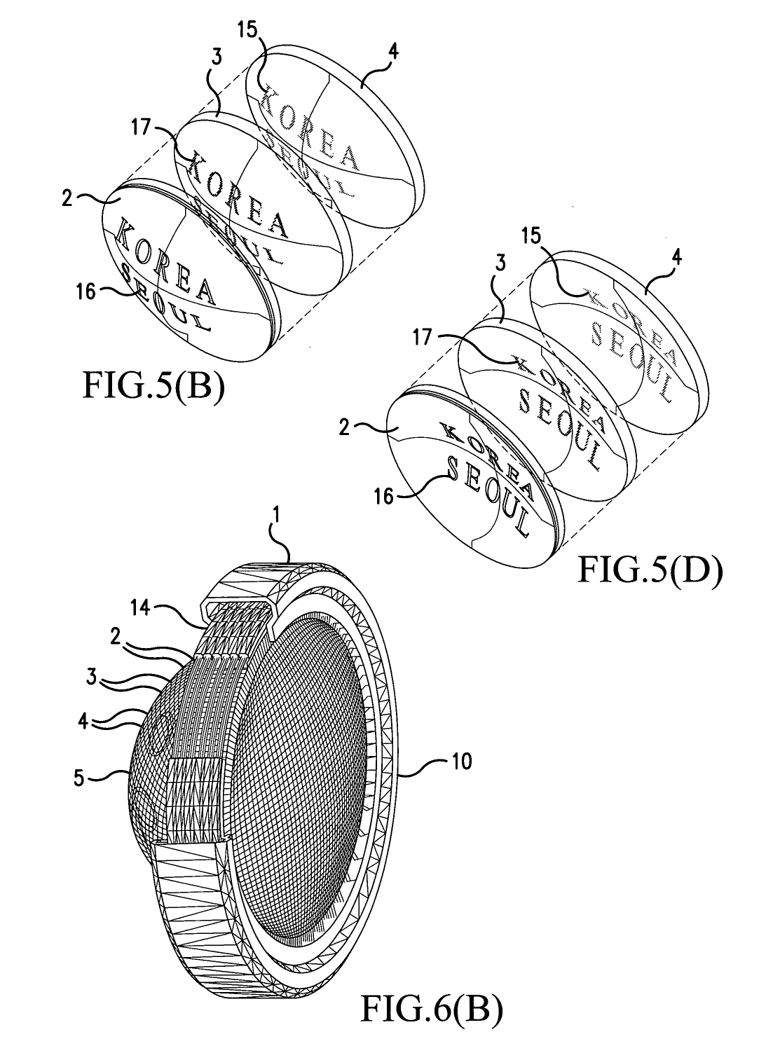

FIGS. 4, 5(A)-5(D) show an example of use of color sheets 13 attached on the specifically angled and segmented surfaces 2C, 3C and 4C of three curved plastic plates 2, 3 and 4. That is, in the case of the edge surfaces of the first curved plastic plate 2, a green sheet may be attached to first color segment 2C-1 of each angled and segmented surface, a scarlet sheet may be attached to second color segment 2C-2 and a purple sheet may be attached to third color segment 2C-3. In such a case, the incident color beams received into the curved plastic plate 2 through three differently angled color segments 2C-1, 2C-2 and 2C-3 of each angled and segmented surface, are reflected or refracted at grooves formed on the surfaces of the curved plastic plates 2 due to the inscription of letters and/or figures.

The light beams emitted from the light bulbs 6 are transmitted into the transparent and curved plastic plates 2, 3 and 4 after passing through the color sheets 13 attached to the angled and segmented surfaces 2C, 3C and 4C of the curved plastic plates 2, 3 and 4. In such a case, grooves 2a, 3a, and 4a, an internal inscription 15, a pair of V-shaped internal inscriptions 16, and a scratch 17 inscribed by a laser system, reflect and refract the light beams. Colored letters and/or figures are not projected from the remaining portions of the curved plastic plates 2, 3 and 4 but only from the inscribed portions to the curved display surface 5. Thus, the remaining portions form a background illumination without having the differences in luminosity and/or color of the desired advertisements prominently displayed on the display surface 5. As shown in FIGS. 5(A) and 5(C), the guide light panel 15 and the scratch 17 are disposed within the pair of V-shaped internal inscriptions 16.

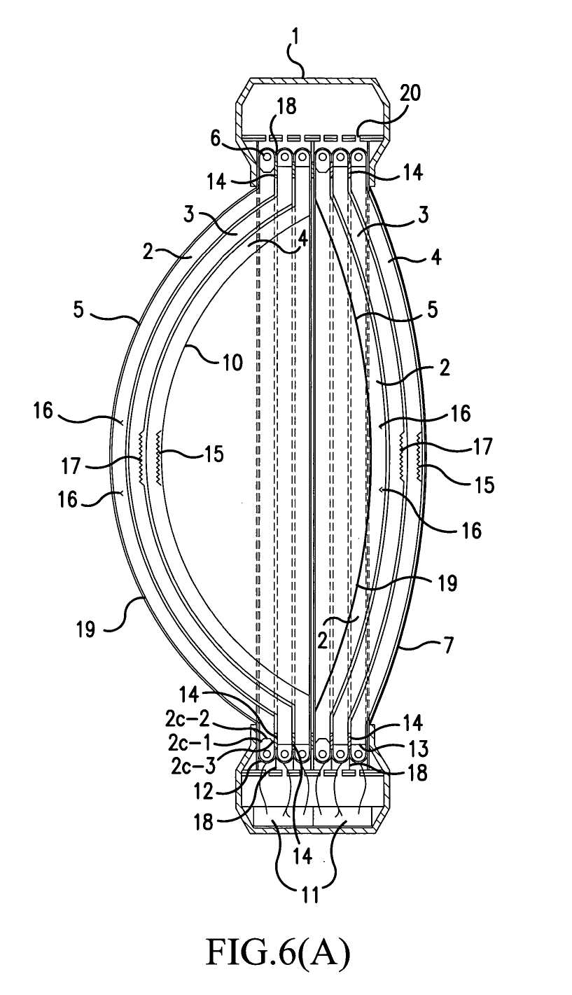

Referring to FIGS. 5(A), 6(A) and 6(B), the display surface 5 is provided with a protective cover 19 disposed thereon and is made of a specifically processed transparent and curved plastic plate or glass which has a reinforced surface. The advertising lighting and interior display according to the present invention can be used in indoor and outdoor lighting, interior indirect lighting, table lamps, photograph frames, memorial plaques, advertising displays, glass showcases, glass doors, mirrors, windows, glass tables, and the like.

Referring in detail to FIGS. 1-6(B), when it is desired to display the words “KOREA SEOUL” on the curved surface 5 consisting of three transparent acrylic plastic plates 2, 3 and 4, the words “KOREA SEOUL” is inscribed on the plastic plates 2, 3 and 4.

That is, the letters “KOR”, designated by the reference numeral 2a, of the word “KOREA” are inscribed on the upper portion of the rear surface of the first curved plastic plate such as convex or concave plate 2, while the remaining letters “EA”, designated by the reference numeral 3a of the word “KOREA” are inscribed on the upper portion of the rear surface of the second curved plastic plate such as convex or concave plate 3 at a position aligned with the position of the letters “KOR” of the first curved plastic plate 2. Thereafter, the letters “SEO”, designated by the reference numeral 4a, of the word “SEOUL” are inscribed on the lower portion of the rear surface of the third curved plastic plate such as convex or concave plate 4, while the remaining letters “UL”, designated by the reference numeral 4b, of the word “SEOUL” are inscribed on the lower portion of the front surface of the same plate 4 at a position aligned with the position of the letters “SEO” of the rear surface. The light illuminated display board of the present invention thus completely displays the word “KOREA SEOUL” on its curved surface 5 due to the light refraction and reflection effect.

Thereafter, a plurality of color sheets 13, each precisely cut in accordance with an appropriate program suitable for accomplishing the operational effect of the display board for displaying desired letters, figures and their color combination on the curved surface 5, are attached to the angled and segmented surfaces 2c, 3c and 4c of the curved plastic plates 2, 3 and 4. When the plastic plates 2, 3 and 4 are illuminated by light from the bulbs 6, the inscribed letters and/or figures of the curved plates 2, 3 and 4 are displayed on the display surface 5 while being desirably colored. An example of coloring the letters and/or figures of the display board will be described hereinbelow.

As shown in FIG. 4, different color sheets are attached to the three precisely cut surface segments 2c-1, 2c-2 and 2c-3 of each specifically angled and segmented edge surfaces 2c of the first curved plate 2. That is, a green sheet is attached to the first segment 2c-1, a scarlet sheet is attached to the second segment 2c-2, and a purple sheet is attached to the third segment 2c-3. On the other hand, a red sheet is attached to each of the two surface segments of each angled and segmented edge surface 3c of the second plastic plate 3. In the case of the third plastic plate 4, with each angled and segmented edge surface 4c consisting of two surface segments, a yellow sheet is attached to one surface segment corresponding to the inscribed letters “SEO” 4a, while a blue sheet is attached to the remaining surface segment corresponding to the inscriber letters “UL” 4b. When all the light bulbs 6 of the display board are turned on to illuminate the three curved plastic plates 2, 3 and 4, the inscribed letters “KOR” 2a of the first plate 2 are illuminated in all directions by light beams having three different colors, i.e., green, scarlet and purple. On the other hand, the inscribed letters “EA” 3a of the second curved plate 3 are illuminated in all directions by red light beams. Therefore, the word “KOREA” is clearly displayed on the upper portion of the curved surface 5 of the display board as shown in FIG. 1 while being colored in four colors, i.e., green, scarlet, purple and red.

On the other hand, the inscribed letters “SEO” 4a of the third curved plastic plate 4 are illuminated in all directions by yellow light beams, while the inscribed letters “UL” 4b of the same plate 4 are illuminated in all directions by blue light beams. Therefore, the words “KOREA SEOUL” are clearly displayed on the curved surface 5 of the display board as shown in FIG. 1 while being illuminated and colored in six colors, i.e., green, scarlet, purple, red, yellow and blue. As described above, it is preferable to accomplish the inscription of desired letters, figures or symbols on the transparent acrylic plastic plates of the display board according to the present invention by directly inscribing the letters, figures or symbols on the plastic plates at corresponding positions as shown in FIG. 3. Such plastic plates are, thereafter, closely laminated together, with the inscribed portions of the plates being precisely aligned with each other.

Referring in detail to FIGS. 5(A)-5(D), in place of the direct inscription of the letters, figures or symbols on three convex or concave configured plastic plates 2, 3 and 4, first of all, it is possible to form the desired letters, figures or symbols on the plastic plates by utilizing the internal inscriptions 16 having the V-shaped internal inscription disposed on the rear surface of the first convex or concave configured plate 2 whereby the internal inscriptions 16 are formed along the edges of the desired letters, figures or symbols as outlines. In such a case, the rear surface 10 of the second convex or concave configured plastic plate 3 is scratched at areas corresponding to the closed areas within the internal inscription 17 of the first plate 2, thus having the V-shaped internal inscription 16.

In order to improve intensity of illumination and clear color of the advertising lighting and interior display according to the present invention, the third convex or concave configured plastic plate 4 is scratched, the internal inscription on the back surface thereof being the same as the front scratch 17 thereof to function as a kind of a guide light panel. Thus, the V-shaped internal inscription 16 of the first curved and transparent acrylic plastic plate 2, the scratch 17 of the second curved and transparent plastic plate 3, and the internal inscription 15 of the third curved and transparent plastic plate 4 are attached, one on the other, and the curved display surface 5 has a back lighting function of the guide light panel for improving value and luminance of the display according to the present invention.

Thereafter, the above three convex or concave configured and transparent acrylic plastic plates 2, 3 and 4 are laminated together in a way such that the outline grooves 16 of the first plate 2, the scratched areas 17 and color sheets 13 of the second plate 3 and the color sheets 13 of the third plate 4 are completely aligned with each other. The three laminated plastic plates 2, 3 and 4 are, thereafter, set within the display board frame 1, thusforming a desired display board as shown in FIG. 5(A). Such a display board clearly displays the desired letters, figures or symbols on its display surface 5 while accomplishing a desired cubic effect and a desired pastel effect. In such a case, the cubic curved display surface 5 is shown as if it is deeply submerged into the interior of the board. On the other hand, the pastel effect accomplishes enhanced light intensity of the display board due to the color sheets 13 particularly in daylight in addition to the nighttime.

Therefore, the lighting and interior display according to the present invention effectively displays desired letters, figures and symbols in a variety of colors while accomplishing a desired color alteration effect, enhanced light intensity and controllable brightness of the display surface, and a desired cubic effect. In addition, since opposite surfaces of each transparent acrylic plastic plate in the display board of the present invention may be used for the inscription of desired letters, figures or symbols, it is possible to preferably save the plastic plates. The display board of the present invention may be almost permanently reusable, thus being free from forcing a user to repeatedly repair the board or change the board with a new one.

In the display board of the present invention, the light transmitting color sheets 13, having a variety of colors, are attached to the specifically angled and segmented surfaces 2c, 3c and 4c of the plastic plates 2, 3 and 4, thus accomplishing a desired displaying effect of the display board with a variety of hues. When the above color sheets 13 are illuminated by the light bulbs 6, which are separated from each other by the lamp partition plates 18 and where both the activated order and the light intensities are controlled by the PLC 11, it is possible for the display board to display the letters, figures and symbols on its curved display surface 5 in a variety of colors. For example, four different color sheets 13, e.g., a red sheet, a blue sheet, an orange color sheet and a yellow sheet, are attached to the specially angled and segmented surfaces 2c, 3c and 4c of the convex or concave configured plastic plates 2, 3 and 4, and are illuminated by the light bulbs 6 under the control of the PLC 11. The advertisements or notices, formed of the letters, figures and/or symbols inscribed on the surfaces of the plastic plates 2, 3 and 4, are thus clearly displayed on the display surface 5 while being illuminated by a single color light beams, such as red beams or blue beams, or multi-color light beams. In such a case, the display board accomplished a desired animation effect, which allows the advertisements or notices to be shown as if they move on the curved display surface 5. The display board may be also designed to periodically change the colors of light beams while displaying the advertisements or notices on its curved display surface 5.

That is, the light bulbs 6 of the display board according to the present invention may be selectively activated under the control of the PLC 11, and so the display board preferably accomplishes a fade-in and fade-out effect in addition to the animation effect. Due to such a fade-in and fade-out effect, the colors of light beams, passing through the color sheets 13 of the specifically angled and segmented edge surfaces 2c, 3c and 4c of the convex or concave configured transparent acrylic plastic plates 2, 3 and 4, are instantaneously and completely altered. Due to a combination of the fade-in and fade-out effect with the animation effect, the desired advertisements or notices are thus variously and fantastically displayed on the display surface 5 while being illuminated by a variety of color beams. When such light illuminated display boards of the present invention are used as conventional billboards, interior boards, Integrated image boards for logo & brand, sales advertising boards, and shades for lamps, they accomplish a desired advertising or noticing effect.

The specifically designed and convex or concave configured transparent acrylic plastic boards of the present invention may be preferably used as the material of shades for indoor lamps, such as floor lamps and table lamps, since such transparent acrylic plastic plates refract and reflect light beams at their specifically angled and segmented edge surfaces in addition to their flat edge surfaces as described for the light illuminated display boards. When the invention is adapted to the shades of indoor lamps, it is possible to enhance the interior decoration effect of the lamps in addition to displaying beautiful color figures, color letters or color characters on the shades. Lamps, with shades capable of displaying color letters, figures, patterns, designs or a combination thereof, also may be used for commercial applications to accomplish an enhanced advertising effect.

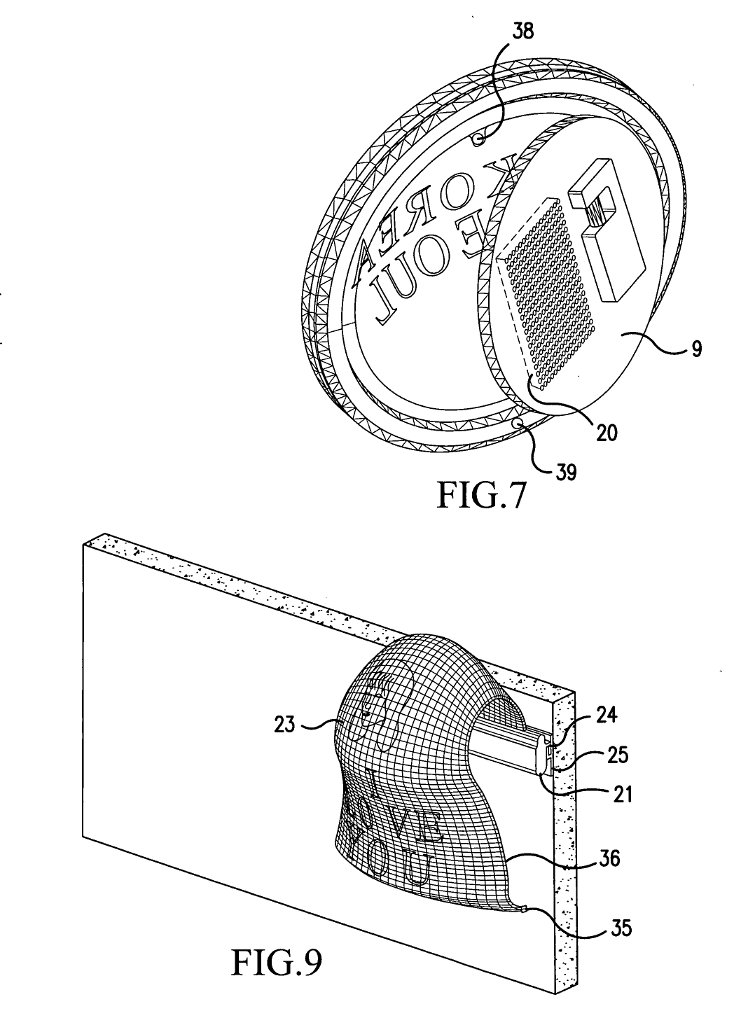

Referring in detail to FIG. 7, there is illustrated a second embodiment of an advertising lighting and interior display in accordance with the present invention. The advertising lighting and interior display of the present invention includes the display board frame 1, a board frame type speaker 9 which is used as an advertising speaker, an air purifier 20 for cleaning air such as smoke, dust and bacteria, etc., a wireless sensor alarm device 39 and a lookout camera 38 for checking a stranger. The board frame type speaker 9, the air purifier 20, the lookout camera 38 and the wireless sensor alarm device 39 are disposed on the back surface of the display board frame 1.

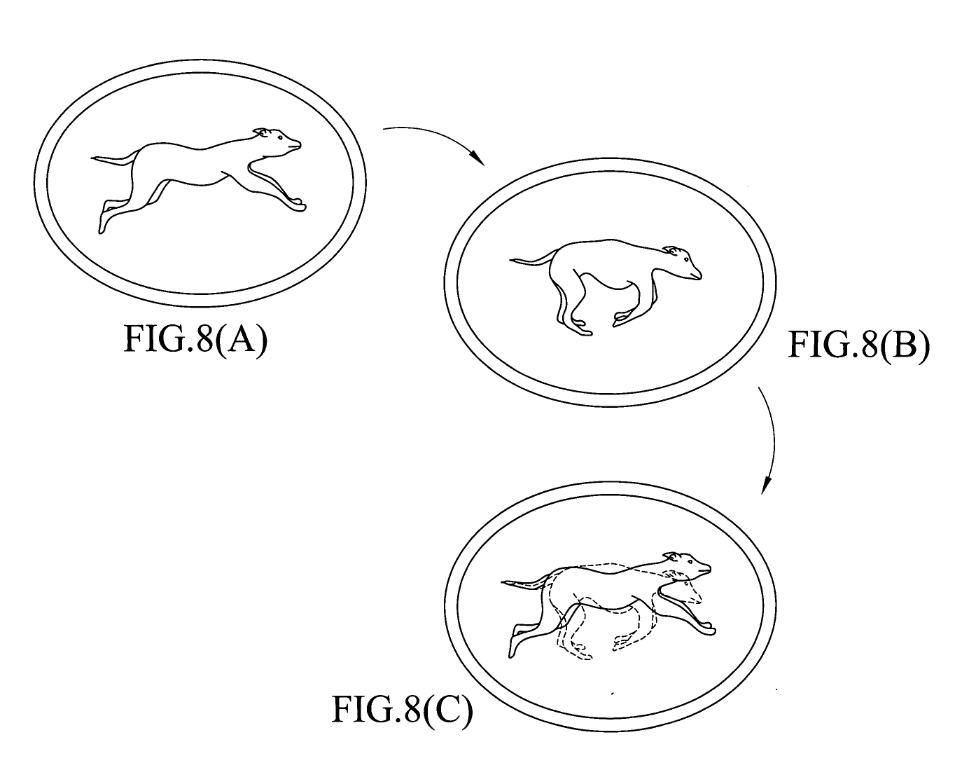

FIGS. 8(A)-8(C) are examples of diagrammatic front views of the advertising display board in a three-step animation operation according to the present invention. The animation operation of the advertising display boards I created by changing the light color on an elliptical surface and cut surfaces such as the first cut angled and segmented surface 2C-1, the second cut angled and segmented surface 2C-2 and the third cut angled and segmented surface 2C-3 of the concave and convex transparent plates 2, 3 and 4 as shown in FIG. 6(A). That is, the animation operation is achieved by the fade-in and fade-out volume of light from the bulbs 6 which are controlled by PLC 11.

That is, a moving picture of an animal is internally inscribed by the worker on convex and concave surfaces of the first, second and third transparent glass or acrylic plastic plates 2, 3 and 4. Thereafter, the elliptical angled and segmented surfaces 2C, 3C and 4C, and the first, second and third cut angled and segmented surfaces 2C-1, 2C-2 and 2C-3 are sequentially illuminated by the bulbs 6 with different color and light in intensity. Therefore, as shown in FIGS. 8A to 8C, the picture of the animal is moving continuously as a living animal.

The advertising lighting and interior display system according to the present invention, as shown in FIGS. 6(A) and 6(B), can function as separate convex and concave display surfaces in a single body. Thus, the advertising lighting and interior display of the present invention can be used for creating an interior design, a bland image, a sales promotion advertisement, an internal advertising board speaker, a indoor air cleaner, a souvenir, a memorial plaque, and the like. Also, the advertising lighting and interior display according to the present invention can be used as a personal item or a household appliance, such as art work, a favorite proverb, or a famous maxim which is inscribed internally and sculptured externally in two or three dimensions. More specifically, a portrait or a landscape painting can be displayed by irradiating using a guide light panel function since colors or color printed photo films can be inserted on the sculptured surface thereof.

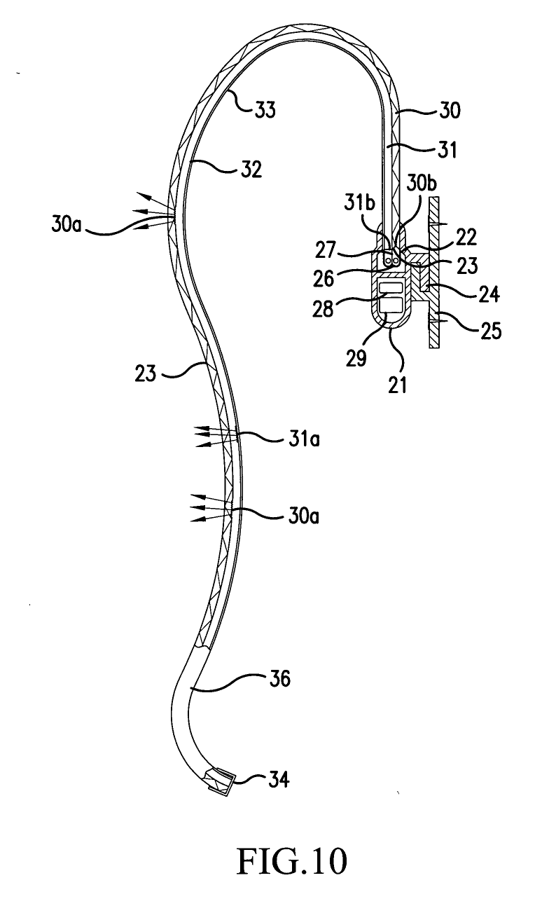

An indirect convex configured advertising display board such as a wall tapestry shade, a wall tapestry ring shade, or a ceiling shade according to the present invention, is illustrated in FIGS. 9-13. These wall tapestry, wall tapestry ring and ceiling convex shades 23 for a cold cathode fluorescent lamp 22 are made of a transparent glass, crystal or acrylic plastic. These convex shades 23 can include at least one layer such as a first layer 30 and a second layer 31. As shown in FIGS. 9 and 10, the first and second layers 30 and 31 are inscribed with a first inscription 30a and a second inscription 31a, respectively.

Within an upper portion 35 of the convex shade 23, the cold cathode fluorescent lamp 22 and a lamp partition 27 are disposed. A reflection mirror 26 is correspondingly disposed with a cutting surface of the first and second layers 30 and 31 of the convex shade 23. An inverter 28 and a second PLC 29 are mounted on a rear plate 33 of the fluorescent lamp 22, and the illumination frame 21. The wall tapestry 24 is attached to an outer surface of the illumination frame 21 and a support bracket 25 is attached to the wall tapestry 24. The convex lamp shade 23 as shown in FIGS. 9 and 10 has a semicircular configuration disposed on an upper portion thereof, which includes the circular fluorescent lamp 22 disposed therewithin. The fluorescent lamp 22 is disposed within the support bracket 25, which is attached to the wall tapestry 24.

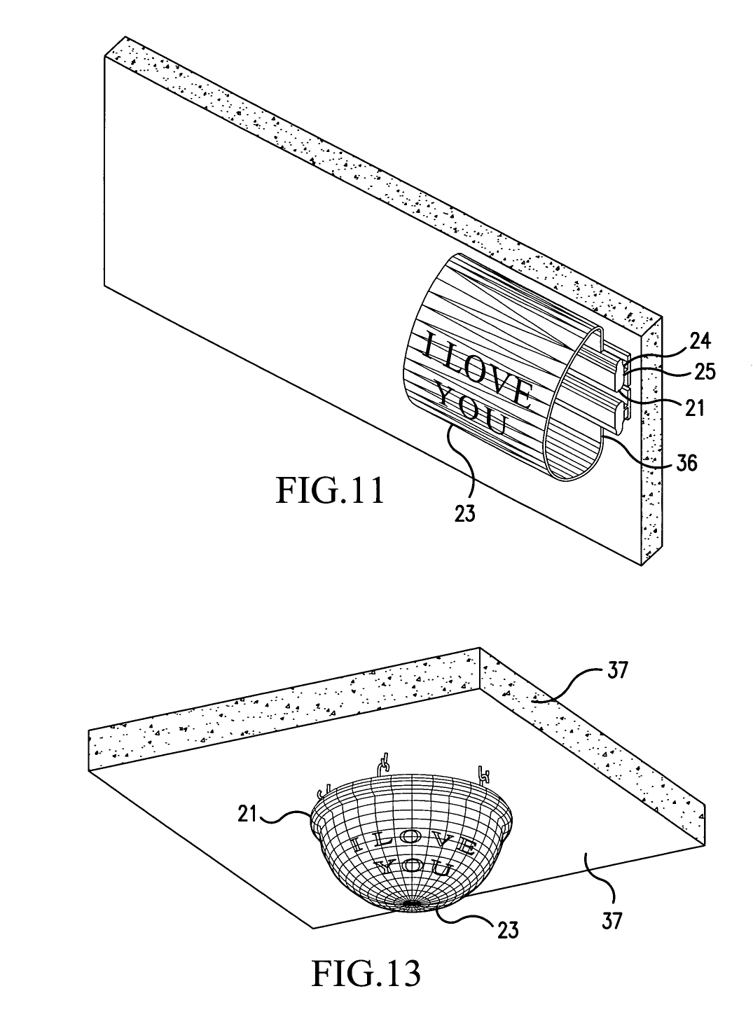

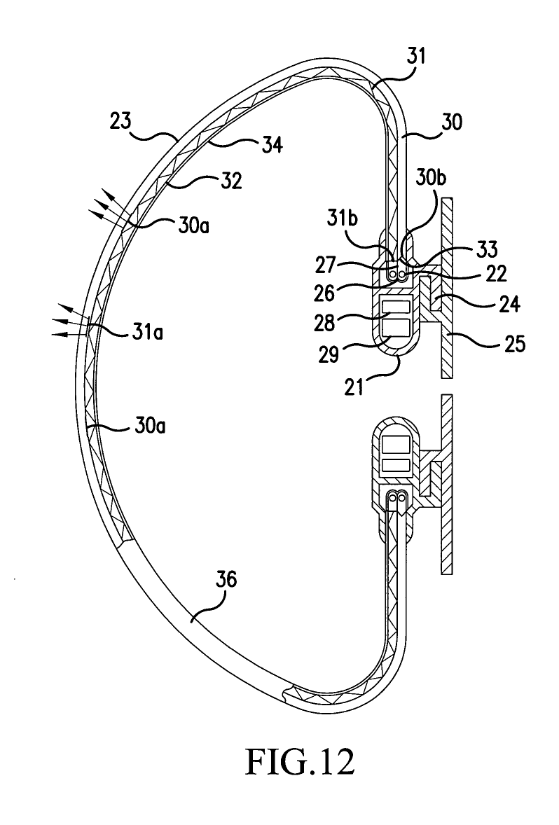

Referring in detail to FIGS. 11 and 12, within upper and lower portions 35 and 36 of the convex shade 23, a pair of cold cathode fluorescent lamps 22 are disposed. Therefore, at both upper and lower portions 35 and 36 of the convex shade 23, the upper portion 35 of the convex shade 23, as shown in FIGS. 9 and 10, functions automatically, so that this convex lamp shade 23 can be effectively operated by lighting the ray from the cold cathode fluorescent lamp 22 at the first and second lower edge surfaces 30b and 31b of the lamp shade 23.

Accordingly, as shown in FIGS. 10 and 12, the first and second transparent acrylic plastic layers 30 and 31 includes lower edge surfaces 30b and 31b, respectively disposed at the inside reversed frustum part of the convex shade 23 being used as light receiving surfaces that receive light from the circular cold cathode fluorescent lamp 22 into the convex shade 23. Also, the first and second layers 30 and 31 of the convex shade 23 are inscribed with the first and second grooves 30a and 31a of the desired letters, symbols, or figures. A transparent or translucent color sheet 33a is attached to the interior surface of the outside frustum part of the convex shade 23. In such a case, any colored letters, figures or symbols are not projected from the remaining parts of the first and second layers 30 and 31, except for the inscribed portions to the external surface of the convex shade 23. The above remaining parts of the two layers 30 and 31 thus form a background illumination without having a difference in luminosity or color. Therefore, the desired letters, figures or symbols are clearly and prominently displayed on the external surface of the shade while being illuminated by light in the same manner as that described for the light illuminated display board.

Referring in detail to FIG. 13, the ceiling lampshade 23 is secured to a ceiling 37 through the illumination frame 37 and includes the lamp 22 disposed therewithin. The lamp 22 is connected to the second PLC 29 for displaying a variety colors in a second or third dimension. Accordingly, the ceiling lampshade 23 according to the present invention, as shown in FIG. 13, can be applied to a household nightstand.

When it is desired to display a sentence “I LOVE YOU”, as an example, on the external surface of the lampshade as shown in FIGS. 9, 11 and 13, the sentence “I LOVE YOU” is inscribed on the first and second plastic layers 30 and 31 of the shade 23 as follows.

That is, the word “I”, designated by the reference numeral 30a, of the sentence “I LOVE YOU” is inscribed on the upper portion of the rear surface of the first plastic layer 30, while the word “YOU”, designated by the reference numeral 30a, is inscribed on the rear surface of the first plastic layer 30 at a lower position spaced from the word “I” to the right. On the other hand, the word “LOVE”, designated by the reference numeral 31a, is inscribed on the rear surface of the second plastic layer 31 at a position aligned with the word “I” of the first layer 30. When the two laminated plastic layers 30 and 31 of the shade 23 are illuminated by light of the fluorescent lamp 22, the desired sentence “I LOVE YOU” is clearly displayed on the external surface of the shade 23 when light-illuminated. Since each of the grooved edge surfaces 30b and 31b of the two plastic layers 30 and 31 are precisely formed to have two or three surface segments having different angles, with a color sheet being attached to each surface segment, it is possible to give desired colors to the sentence “I LOVE YOU” displayed on the external surface of the shade.

FIGS. 10 and 12 show an example of use of such color sheets attached on the specifically angled and segmented edge surfaces 30b and 31b of the two plastic layers 30 and 31. That is, in the case of the grooved edge surface 30b of the first plastic layer 30, a green sheet may be attached to each of the two surface segments. In the case of the grooved edge surface 31b of the second plastic layer 31, two red sheets are attached to the outside surface segments of the three segments, with a yellow sheet being attached to the middle surface segment of the three segments. When the fluorescent lamp 22 of the lamp is turned on, the words “I” and “YOU” are displayed on the external surface of the shade 23 while being illuminated by green light. On the other hand, the word “LOVE” is displayed on the external surface of the shade while being illuminated by red light at its upper portion and by yellow light at its lower portion, with the middle portion between the upper and lower portions of the word “LOVE” being illuminated by faint blended color light.

Accordingly, the present invention provide a light illuminated and curved configured display board and a lampshade using light refraction and reflection effect in the laminated transparent acrylic plastic plates. In the present invention, each of the laminated plastic plates is precisely cut at edge surfaces thereof to form specifically angled an segmented edge surfaces individually having two to five surface segments. In addition, at least one of opposite surfaces of each plastic plate is inscribed with desired letters, symbols or figures. Therefore, the convex or concave display board or the shade 23 of the present invention clearly display the desired letters, symbols or figures on its display surface while illuminating them using a variety of color light beams in addition to saving the transparent acrylic plastic plates, glass or crystal. In addition, each transparent acrylic plastic layer of the present invention may be provided with grooves having a V-shaped crosssection, scratched areas, and specifically cut color sheets on at least one of opposite surfaces thereof, thus accomplishing a clear displaying effect in addition to a cubic effect for the desired letters, symbols or figures.

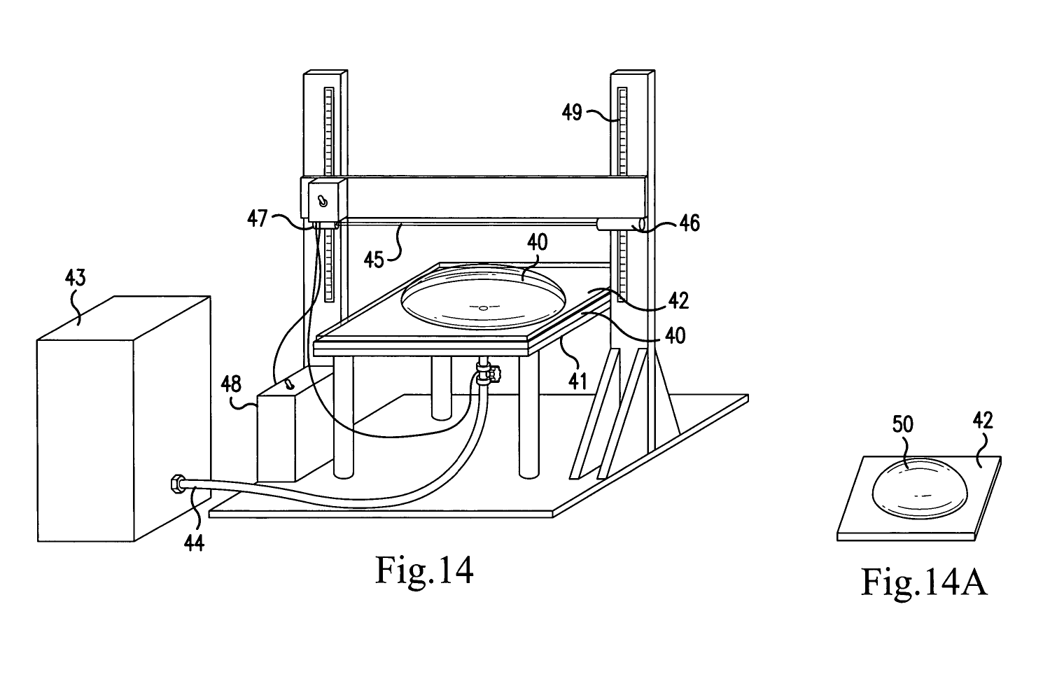

The convex and/or concave surfaces used in the display device of the present invention can be manufactured by referring to FIG. 14 of the present application.

A flat plate 40 of transparent material, e.g., a plastic material such as an acrylic plastic plate, a glass plate or a crystal plate is secured in a work table 41 within a mold 42, where it is heated to about the molding temperature of the plate, without destroying the indicia previously engraved on one or more surfaces of the plate. The molding temperature must take into consideration the particular material of the plate, and the depth and spacing of the engravings on the plate, but can be about 80° to 90° C. Compressed air is then introduced from compressor 43 through air hose 44 to one side of the heated plate sufficient to cause the plate to expand. For example, if the plate has a thickness of about 2 to 4 mm, compressed air at a pressure of up to about 3 kgf/cm², may be necessary to cause the plate, which is fixed at its periphery within a template, to expand along its surface. A thickness of 5 to 10 mm may require the pressure of compressed in an amount of about 4 kgf/cm² or more. The introduction of compressed air, to the mold 42 can be applied 2 or 3 times, in spurts, until the plate hardens. Advantageously, a base bearing 45 is generated by laser generator 46 to extend over the expanding produced, so that the application of the compressed air can be discontinued by the air control unit 47 and associated power supply 48, when the expanding plate interrupts the laser beam. Of course, the height of the laser beam above the plate can be adjusted by a scale 49, depending on the extent of expansion desired in the plate product. The plate can be heated while in the mold or prior to its introduction into the mold, and the surfaces of the plate can be etched either prior to or after the formation of the convex or concave surfaces. Advantageously, the surface of the plate can be selectively modified by varying the direction and location of the compressed air.

In a further embodiment of the present invention, FIGS. 14A shows that the mold can include a cap member 50 which functions to limit the expansion of the convex or concave portion of the display surface in a predetermined manner. Thus, surface uniformity or non-uniformity can be achieved in the expanded display surface.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An advertising lighting and display device which comprises:
at least one curved, transparent plate provided with indicia etched into at least one of the surfaces thereof;
a light source operatively associated with at least a portion of the edges of said curved plate, said edges having angled and segmented surfaces for increasing the quantity of incident light from the light source with a plurality of light-transmitting color sheets of variable colors attached to said angled and segmented surfaces; and
a programmable logic controller operatively connected to the light source for controlling the light color and sequence thereof to be delivered to the edges of the curved plate and ultimately displayed on the curved surface of the display device.

2. The device of claim 1, wherein the curved, transparent plate has a convex or concave configuration.

3. The device of claim 1, wherein a plurality of curved, transparent plates are laminated together, each of said plates being adapted to contain etched indicia on the surface thereof.

4. The device of claim 1, wherein a back plate extends across the convex or concave configured plate.

5. The device of claim 1, wherein at least one convex and at least one concave configured transparent plate are combined together in an opposing manner to define the display surfaces.

6. The device of claim 1, wherein the periphery of the curved, transparent plate terminates as a flat end portion and said light source is operatively associated with said flat end portion.

7. The device of claim 1, wherein the transparent plate is made of a material selected from the group consisting of a plastic material, a glass material and a crystal material.

8. The device of claim 1, mounted in a display board which further contains a mirror, a speaker, an air purifier, a wireless sensor alarm, and a lookout camera.

9. A method for manufacturing a curved, transparent plate which comprises:
mounting a flat transparent plate within a mold;
heating the flat transparent plate to about its molding temperature;
introducing a compound gas to one side of the transparent plate, sufficient to cause the plate to expand in a convex or concave manner, and, after it has cooled;
removing the curved, transparent plate form the mold.

10. The method of claim 9, wherein the transparent plate is selected from the group consisting of a plastic material, a glass material and a crystal material.

11. The method of claim 9, wherein at least one of the surfaces of the transparent plate is etched with indicia prior to being heated to its molding temperature.

12. The method of claim 9, wherein the molding temperature is about 80°-90° C.

13. The method of claim 9, wherein the compressed gas is air which is introduced at a pressure of about 3 to 4 kgf/cm².

14. The method of claim 13, wherein the transparent plate has a thickness of about 2 to 10 mm.

15. The method of claim 9, wherein a laser beam extends at a predetermined distance over the transparent plate and the compressed gas is introduced until the curvature in the transparent plate interrupts the laser beam.

16. The method of claim 9, wherein a solid cap extends over the transparent plate and the compound gas is introduced until the curvature of the transparent plate corresponds to that of the solid cap.

17. A device for manufacturing a curved transparent plate which comprises:
a mold;
means for mounting a flat transparent plate within the mold;
means for heating the flat transparent plate to its molding temperature;
means for mounting a height-measuring device above the mold; and
means for introducing a compressed gas to one side of the transparent plate sufficient to cause the plate to form a curved surface with a height controlled by the height-measuring device.

18. The device of claim 17, wherein the height-measuring device is a laser beam.

19. The device of claim 17, wherein the height-measuring device is a solid cap member.
